(19) United States
(12) Patent Application Publication
(10) Pub. No.: US 2002/0112912 A1
(43) Pub. Date: Aug. 22, 2002

(54) System and method for activating a brake system for an automotive vehicle

(76) Inventors: Steven Lee Napier, Canton, MI (US); Timothy Allen Huls, Plymouth, MI (US)

Correspondence Address: Kevin G. Mierzwa, Artz & Artz PLC, Suite 250, 28333 Telegraph Road, Southfield, MI, 48034, US

(21) Appl. No.: 09/789,679

(22) Filed: Feb. 21, 2001

(51) Int. Cl. B60T 7/12; B60T 7/22

(52) U.S. Cl. 180/275

(57) ABSTRACT

A system and method for actuating a brake system (20) of an automotive vehicle that has an airbag controller (12) which generates an airbag activation signal in response to a predetermined vehicle condition such as deceleration. A speed sensor (34) is used to generate a speed signal in response to vehicle speed. A brake controller receives the speed signal and the airbag activation signal. The brake controller (20) actuates brakes (24) of automotive vehicle (10) in response to the vehicle speed signal indicative of at least a predetermined speed and the airbag activation signal.

### TECHNICAL FIELD

The present invention relates generally to brake systems for automotive vehicles, and more particularly, to automatically actuating brake systems during an incapacitation of the automotive vehicle.

### BACKGROUND

During the operation of an automotive vehicle, upon an impact, the driver may be temporarily incapacitated or disoriented. This may cause the vehicle operator to either delay in actuating the brakes after an event or not be capable of actuating the brakes in the case of a crash event.

It would therefore be desirable to provide an automatic brake actuation system in which the brakes of the vehicle are automatically applied to bring the vehicle to rest after a crash event.

### SUMMARY OF THE INVENTION

It is therefore one object of the invention to provide a brake actuation system capable of bringing the vehicle to a stop after a crash event. In one aspect of the invention, such a system comprises an airbag module for generating an airbag activation signal in response to a predetermined vehicle condition. A vehicle speed sensor generates a speed signal in response to a vehicle speed. A brake controller receives the speed signal and the airbag activation signal and actuates the brakes in response to the vehicle speed signal indicative of at least a predetermined vehicle speed and said airbag activation signal.

In a further aspect of the invention, a method of operating a brake system comprises the steps of:

generating an airbag activation signal in response to a predetermined vehicle condition;

generating a speed signal in response to a vehicle speed; and,

actuating said brakes in response to a vehicle speed signal indicative of at least a predetermined vehicle speed and said airbag activation signal.

One advantage of the invention is that should the driver not be rendered incapacitated and the accelerator pedal or brake pedal is actuated, then the system will allow the vehicle to be controlled thereby.

Other objects and advantages of the present invention will become apparent upon considering the following detailed description and appended claims, and upon reference to the accompanying drawings.

### BRIEF DESCRIPTION OF THE DRAWINGS

FIG. 1 is a block diagrammatic view of an automotive vehicle having a brake actuation system according to the present invention.

FIG. 2 is a flow chart of the operation of a brake activation system according to the present invention.

### DESCRIPTION OF THE PREFERRED EMBODIMENT(S)

The following description is set forth with respect to a vehicle speed as a control-indicative event. However, other electrical signals may be used to indicate that the vehicle is under driver control.

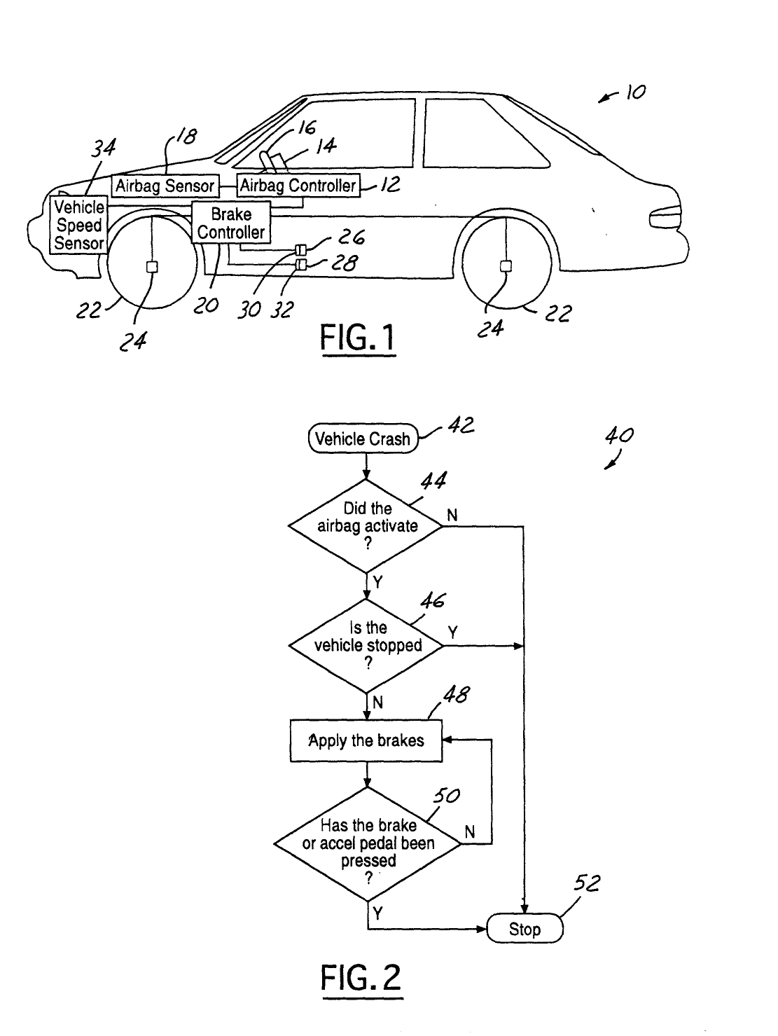

Referring now to FIG. 1, an automotive vehicle 10 is illustrated having an airbag controller 12 coupled to an airbag 14 positioned on a steering wheel 16 of an automotive vehicle. An airbag sensor 18 is coupled to airbag controller 12. Airbag sensor 18 may be one of a variety of types of sensors that sense the presence of a predetermined vehicle condition. For example, airbag sensor 18 may be an acceleration sensor that senses a rapid deceleration of an automotive vehicle. Various types of deceleration sensors including MEMS devices may be used. Airbag sensor 18 may also include a safing sensor which prevents the airbag from actuating upon an electrical disturbance in the vehicle not related to the predetermined automotive condition. In response to the airbag sensor signal 18, airbag controller 12 generates an airbag activation signal which in turn operates airbag 14. Various numbers of types and kinds of airbags may be positioned in the vehicle including a driver side airbag, a passenger side airbag, and side airbags. Airbag sensor 18 is meant to incorporate the required sensors for the various types of airbags. The airbag activation signal may be derived from any one or all of the types of airbags.

Automotive vehicle 10 also includes a brake controller 20. Brake controller 20 may be a microprocessor-based system. Brake controller 20 controls the activation of some or all of brakes 24 of wheels 22. Preferably, brakes 24 are electronically actuated. Such a system is particularly suitable for a brake-by-wire brake system. However, the present invention applies equally to systems which include hydraulic brake actuation. Parking brake may also be included in brakes 24.

Automotive vehicle 10 has an accelerator pedal 26 and a brake pedal 28. Accelerator pedal 26 has an accelerator pedal sensor 30 and a brake pedal sensor 32. Acceleration pedal sensor 30 and brake pedal sensor 32 generate a respective acceleration pedal actuation signal and a brake pedal actuation signal indicative of the actuation or depression of each of the pedals. The sensors 30 and 32 may be, for example, implemented as a switch. Although illustrated as separate discrete sensors, the sensors 30 and 32 may be implied. That is, the operation of the throttle through a throttle position sensor may be used as an accelerator pedal sensor. The actuation or non-actuation of brakes may be used as a brake pedal sensor 32. The pedal actuation signals may, for example, be coupled to brake controller 20.

Automotive vehicle 10 also has a vehicle speed sensor 34. Vehicle speed sensor 34 generates a vehicle speed signal corresponding to the speed of automotive vehicle 10. Those skilled in the art will recognize various sources of speed signals are typically present in automotive vehicles including sensor used in antilock brakes and transmissions. Vehicle speed sensor 34 is illustrated coupled to brake controller 20, however, airbag controller 12 may also directly receive the vehicle speed signal.

Referring now to FIGS. 1 and 2, a method 40 for operating an automotive vehicle comprises the steps of determining a vehicle crash event starting at step 42. To determine whether the vehicle has crashed, step 44 determines whether the airbag has activated. To determine whether the airbag is activated, airbag controller 12 initiates an airbag activation signal which is coupled to airbag 14. Airbag controller also couples the airbag actuation signal to brake controller 20. If the airbag has actuated in step 44, step 46 determines whether the vehicle is stopped. To determine whether the vehicle is stopped, the vehicle speed is monitored through the vehicle speed sensor. If the vehicle speed signal indicates a speed greater than zero, then the vehicle has not stopped. If the vehicle has not stopped, the brakes are applied in step 48. In step 50, the actuation of the brake or acceleration pedal is monitored to determine whether the brake or acceleration pedal has been pressed. In step 50, the brake pedal or acceleration pedal state is determined by monitoring the acceleration pedal sensor 30 or the brake pedal sensor 32 to determine whether a pedal actuation signal is present. If either of the pedal actuation signals indicates the acceleration pedal or the brake pedal has been activated, the system continues to step 52 in which the method of the present invention is ceased. In step 50, if the brake pedal or acceleration pedal has not been actuated, step 48 is performed. This will bring the vehicle to a stop.

Referring back to steps 44 and 46, if the airbag has not activated or the vehicle is stopped, step 52 is performed to end the method 40.

As an alternative, the brake pedal alone or the accelerator pedal alone may be used in step 50. Preferably, as mentioned above, in step 48 the application of brakes is performed electrically. Also, the speed of the vehicle is monitored to determine whether the vehicle has stopped. If the vehicle is not stopped, the application of brake continues until the vehicle stops or until the brake pedal or accelerator pedal has been depressed.

As an alternative the brakes may be applied until another control-indicative event indicative of the vehicle being under control is received. For example, this may include an ignition “key off” signal.

While particular embodiments of the invention have been shown and described, numerous variations alternate embodiments will occur to those skilled in the art. Accordingly, it is intended that the invention be limited only in terms of the appended claims.

What is claimed is:

1. A system for an automotive vehicle having brakes comprising:
an airbag module generating an airbag activation signal in response to a predetermined vehicle condition;
a control-indicative sensor generating a vehicle control-indicative signal in response to a vehicle condition; and
a brake controller receiving said control-indicative signal and said airbag activation signal, said controller actuating said brakes in response to said control-indicative signal and said airbag activation signal.

2. A system as recited in claim 1 wherein said brake control-indicative sensor comprises a speed sensor generating a spaced signal in response to a vehicle speed, wherein said controller actuates said brakes in response to said vehicle speed signal indicative of at least a predetermined vehicle speed.

3. A system as recited in claim 2 further comprising a pedal activation sensor generating a pedal actuation signal in response to a pedal actuation.

4. A system as recited in claim 3 wherein said brake controller receives said pedal actuation sensor, said controller actuating said brakes in response to a vehicle speed signal indicative of at least a predetermined vehicle speed, said airbag activation signal and in response to said pedal actuation signal indicating said pedal not being depressed.

5. A system as recited in claim 1 wherein said pedal actuation signal is coupled to a brake pedal.

6. A system as recited in claim 1 wherein said pedal actuation signal is coupled to said accelerator pedal.

7. A system as recited in claim 1 wherein said predetermined condition comprises rapid deceleration.

8. A system for an automotive vehicle comprising:
an airbag module generating an airbag activation signal in response to a predetermined vehicle condition;
a vehicle speed sensor generating a speed signal in response to a vehicle speed;
a pedal actuation sensor generating a pedal actuation signal; and
a brake controller receiving said speed signal and said airbag activation signal, said controller actuating said brakes in response to a vehicle speed greater than zero and said airbag activation signal, said brake controller deactuating said brakes in response to a pedal actuation signal.

9. A system as recited in claim 8 wherein said brake controller is electrically actuated.

10. A system as recited in claim 8 wherein said pedal actuation signal is coupled to a brake pedal.

11. A system as recited in claim 8 wherein said pedal actuation signal is coupled to said accelerator pedal.

12. A system as recited in claim 8 wherein said predetermined condition comprises rapid deceleration.

13. A method for operating an automotive vehicle comprising the steps of:
generating an airbag activation signal in response to a predetermined vehicle condition;
generating a speed signal in response to a vehicle speed; and,
actuating said brakes in response to a vehicle speed signal indicative of at least a predetermined vehicle speed and said airbag activation signal.

14. A method as recited in claim 13 further comprising the step of generating a pedal actuation signal in response to a pedal actuation.

15. A method as recited in claim 14 wherein said pedal actuation signal corresponds to a brake pedal actuation.

16. A method as recited in claim 14 wherein said pedal actuation signal corresponds to an accelerator pedal actuation

17. A method as recited in claim 14 further comprising the steps of releasing the brakes in response to said pedal actuation signal.

18. A method as recited in claim 1 wherein said step of actuating said brakes comprises the step of electrically actuating said brakes.

19. A method as recited in claim 13 wherein said predetermined condition comprises rapid deceleration.

20. A method as recited in claim 13 further comprising the step of actuating said brakes until said speed signal indicates said vehicle speed being substantially zero.
